(19) United States
(12) Patent Application Publication
(10) Pub. No.: US 2008/0182669 A1
(43) Pub. Date: Jul. 31, 2008

(54) Game and video cartridge for portable electronic device

(76) Inventor: Alan Amron, Brooklyn, NY (US)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/698,699

(22) Filed: Jan. 26, 2007

(51) Int. Cl. A63F 13/00

(52) U.S. Cl. 463/44

(57) ABSTRACT

A removable game or video cartridge programmed specifically to play on a device having a display such, for example, as a mobile phone, digital camera, PDA, or handheld game machine includes a small bootstrap or start-up program that launches, without any interaction on the part of the operator, a game application or video. The game application or video causes the player device to display a user interface that changes solely in response to user input. In an alternate configuration, the game application or video causes the game or video to display a preset initialization screen representative of a board game (e.g., “Monopoly”) or a set of video controls, (e.g., “Play, Pause, Stop, Forward, Reverse, FF, FR and Esq.”) without any further changes in the display except those which are solely driven by input governed by a set of rules and directions known to the user and not pre-specified by the application itself.

### BACKGROUND OF THE INVENTION

1. Field of the Invention

This invention relates to electronic devices characterized by a display and, more particularly, to handheld electronic devices, on which an application on a memory cartridge can be run.

2. Description of the Related Art

Handheld and transportable electronic devices with visual or audiovisual displays are commercially available in many formats, including such dedicated handheld devices as the Nintendo Gameboy, Nintendo color Gameboy, Sony Playstation PSP, as well as Windows CE handhelds and compatibles, such as those from Sony, NEC, Hewlett Packard, and Palm Pilot, Motorola, SamSung, Nikon, Kodak, Sony, and Cannon. The user of such devices must typically navigate through a sequence of menus and configuration screens before the actual game or video application. For example, in an action game, or role playing game, or sports game, or whatever game or video, the user must elect whether he or she will be playing in accordance with one set of game rules for a single player stand-alone mode, wherein the only opponent is the computer, or with a different set of game rules in the multiple player networked player game mode, where each of the user's interactions causes responses in accordance with a fixed set of defined rules. In either case, the user's conduct and results are visceral, that is, he wins, he loses, he gains or loses a physical possession such as a sword or power pill, and he uses up some amount of time, energy, points, etc. in the process of playing the game, which ultimately determines how long he is allowed to play the game.

It would be desirable to have an electronic apparatus based on a visual display which is capable of launching applications which are completely non-interactive, that is, not characterized by the notion of winning or losing but, rather, adapted to define, without any preliminary configuration or other input on the part of the user—an interface which is driven either solely by user input or, to the extent the display is based upon a preset initialization screen, by a set of rules known to the user and not pre-specified by the application itself.

Some cell phones have on-board content such as games or video clips. However, the applications are limited to what the cell phone manufacturer has loaded on the cell phone. Furthermore, some cell-phones also allow applications to be downloaded. However, this feature uses and is limited by the on-board memory space.

### SUMMARY OF THE INVENTION

The aforementioned deficiency is addressed, and an advance is made in the art, by a display electronic device system comprising a housing, a flat panel display, and a plug-in memory storage module or cartridge for storing data representative of an entertainment application such as a video or game that causes—without any preliminary configuration or other input on the part of the user—the electronic device to display a user interface that changes solely in response to user input. For example, the memory storage module or cartridge may store an Etch-A-Sketch application in which an image is “drawn” upon the display in response to user input. By way of further example, the memory storage module or cartridge may store a board game application the display may constitute a preset initialization screen representative of the board game (e.g., “Monopoly”) with no further changes made to the initial display except those responsive to input by the user, the input being governed by a set of rules known to the user and not pre-specified by the application itself. By way of further example, the storage module or cartridge may store a video so that the screen would display a video (e.g. “Cartoons or a Feature Film) controlled by the input by the user—Play, Pause, Stop, Forward, Reverse, FF, FR, Esc.—upon insertion of the storage module or cartridge.

The device further includes a user input interface operable to cause the application program to initiate changes on the flat panel display. The device itself may be realized in a variety of forms such, for example, as a Sony PSP, a Nintendo Game Boy, a mobile telephone with suitable display, a digital camera, and the like. An especially preferred configuration includes a small, flat housing having a width of no more than 5 inches, a height of no more than 6 inches, and a thickness of less than one inch. The flat panel display is preferably a LCD (Liquid Crystal Display) in color and 3 inches by 3 inches. The plug-in memory module is preferably a solid-state ROM (Read Only Memory) which contains a single game or video application. It is plugged into the device and replaced to play another game or video. The device has user operated buttons, or touch screen buttons, with which the user plays the game or controls the video.

The processor of the device may be set at one of a plurality of different clock speeds based on, for example, commands from the game or video program stored on the removable cartridge. A higher clock speed improves performance when color games or videos are used. A lower clock speed may be used for the color display of monochrome games or videos to, for example, improve battery life.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The various features and advantages of the invention will become apparent from the detailed description of embodiments made hereinafter with reference to the accompanying drawings, in which:

FIG. 1A is a front plan view of the button switch implementation of a device constructed in accordance with the present invention;

FIG. 1B is a perspective view depicting a touch screen implementation of a device constructed in accordance with the present invention;

FIG. 2 is a block diagram depicting the interactions of the various internal components disposed within the housing of the illustrative embodiment of FIG. 1A;

FIG. 3 is an alternative block diagram depicting the interactions of the various internal components disposed within the housing of the illustrative embodiment of FIG. 1B;

FIG. 4 depicts the technique for transferring application program data into the device employed by the present invention;

FIG. 5 is a rear view of a digital camera displaying a video according to the invention; and

FIG. 6 is a view of a cell phone displaying a game interface according to the invention.

### DETAILED DESCRIPTION OF THE PRESENTLY PREFERRED EMBODIMENTS

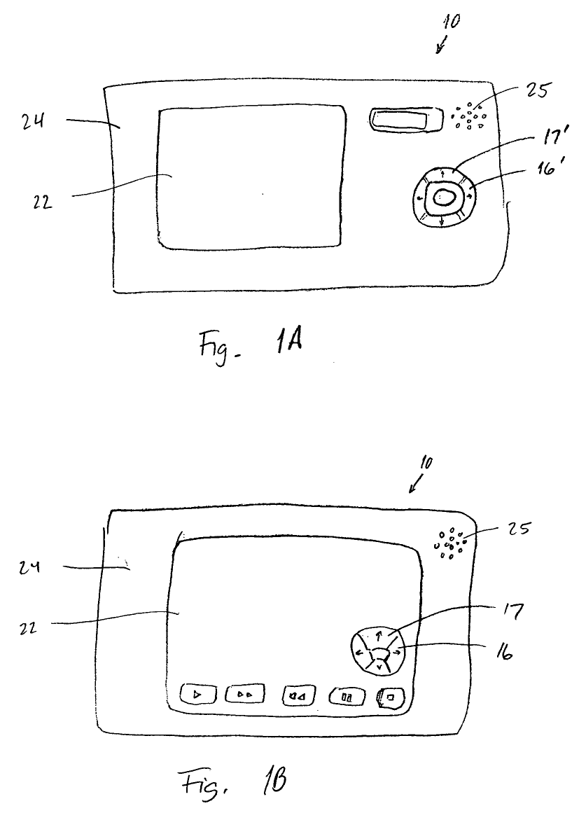

With initial reference to FIGS. 1A and 1B, there is shown an integrated display game or video device 10 which may be utilized in the practice of the present invention. The display game or video device 10 includes a flat panel display 22 disposed within a housing 24. Housing 24 further includes a speaker 25 for audibly reproducing any sounds which may accompany the video program to be stored and played back using device 10. As noted previously, ubiquitous devices such as the Nintendo Gameboy, Sony PSP, a Mobile Telephone with integral display, and a Digital Camera are suitable for realizing the inventive user interface experience contemplated herein.

As best seen in FIGS. 1A and 1B, the illustrative video display housing 24 is thin and flat—in the range of three to seven inches wide, and in the range of four to eight inches long, with a thickness in the range of 0.2 to 2.0 inches being preferred and a thickness of between 0.25 and 0.5 inches being especially preferred. The ratio of each of width and length to thickness may be, for example, at least 3:1 and preferably in the range of 6:1 to 40:1.

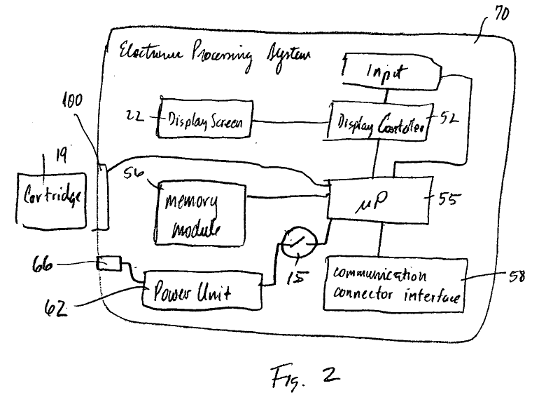

Turning now to FIG. 2, there is shown in block diagram form an illustrative configuration of the electronic processing system employed by display game or video device 10 in accordance with the present invention. As seen in FIG. 2, the electronic processing system 70 of display device 10 of FIG. 1A comprises a display screen 22 mounted within housing section 23, display controller 52, a microprocessor 55 and memory module 56, a communication connector interface 58, a plug-in solid state memory storage unit (ROM) or cartridge 19 for storing input video sequence data, and an internal power unit 62 with rechargeable battery, all configured into a handheld, portable unit.

Memory storage unit 19 serves to store the single game or video application which, in accordance with an illustrative embodiment of the present invention, is received and stored as an encoded data file with microprocessor 56 being configured with appropriate software to function as a file decoder. In accordance with a first embodiment of the invention, the single game or video application is a non-interactive application. By this, it is meant that the application is not characterized by the notion of winning or losing but, rather, merely adapted to define—without any preliminary configuration or other input on the part of the user—a display that is solely defined and altered and or controlled by user input. That it, the device automatically displays an interface related to the single game or video application. For example, in an Etch-A-Sketch adaptation of the invention, the device initializes when the cartridge s inserted by displaying a single blinking cursor at the center of the screen. A manipulandum, as for example, in the form of rocker switches 16′ and 17′ (FIG. 1A) or screen rocker switches 16 and 17 (FIG. 1B) that is capable of movement in any direction within an X-Y coordinate system is operable by the user to cause a shape or object to be “drawn” (i.e., displayed) upon display screen 22. As further example, a video, movie or feature film controlled by a user using the Stop, Play, Pause, Forward, Reverse, FF, FR and Esc. functions already present in the device.

In accordance with another embodiment of the present invention, insertion of the single game or video application stored on memory storage unit 19 into an interface port on the device causes device 10 to display a preset initialization screen which is subsequently altered only as a response to external user directions in accordance with a set of rules known to the user and not pre-specified by the application itself. By way of illustrative example, a board game application is implemented by displaying the board and playing pieces at an initial location. Thereafter, all movements are governed strictly by external events and directions input by the user. Playing a monopoly game, for example, requires rolling a dice and moving the piece to a selected location. The rolling of the dice may be done via either an actual set of dice or a digital simulation executed by the game. In that regard, it is the user (and not the game) which by appropriate input advances a displayed player piece by the number of positions corresponding to the value of the actual or simulated dice roll.

In each of the above embodiment, the memory storage unit 19 includes a programmed coded and formatted request to display the video or game interface. The request is recognized by the device 10 upon insertion of the memory storage device 19 in an interface or upon turning on the device if the cartridge is already in the interface. The device 10 also recognizes through programmed code and format on the memory storage unit 19 that the user control interface of the device can be utilized to manipulate the content of the cartridge. Accordingly, the device 10 changes a current display mode of operation and displays the contents of the game cartridge once the device recognizes the request on the game cartridge. This allows the cell-phone or camera device to be used as an entertainment device for playing the application associated with the cartridge.

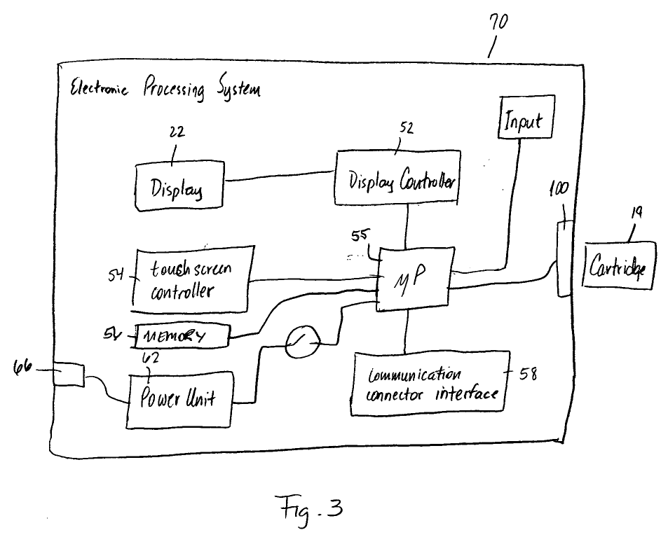

The electronic processing system of the illustrative embodiments of FIGS. 2 and 3 controls and monitors the operations of the display device 10 in accordance with user requests and under software control, the system comprising touch screen controller 54, display controller 52, and microcomputer system 55 with random access memory (RAM) 56. Microcomputer system 55 comprises the CPU which is controlled by the proprietary operating system embedded in a solid state device, the BIOS ROM, and random access memory (RAM) 56 that provides the primary memory space to write, store and retrieve information and program instructions used by the CPU. The microcomputer system 56 comprises a general purpose microprocessor with at least 33 Hz speed and with supporting circuitry such as a logic board with an intel 486DX2/66 MHz processor or better, or with a Pentium processor, a PowerPC processor with supporting circuitry such as a 100 MHz 603e processor, a RISC chip with supporting circuitry, or the like.

The display device 10 is powered from the power unit 62 that comprises one or more rechargeable batteries and power and charging circuits. These power and charging circuits control and distribute battery power or converted AC line power, control the charging of the internal battery or batteries when the device 10 is connected to an external AC adapter/charger device via the AC adapter/charger jack 66 and controls switchover between battery power and external AC line power when the AC power is available via the AC adapter/charger device. The rechargeable battery comprises a lithium ion battery, a nickel hydride (NiMH) battery or the like. To use the system of the present invention, the user actuates an on/off switch 15 which powers up the device. This action automatically applies power to the unit and displays the initial application display screen in accordance with the single game or video cartridge embodiments described above.

In the embodiments of FIGS. 1B and 3, a touch sensitive transparent plate (not shown) covers part or all of the screen and is further comprised of resistive touch, capacitive touch, infrared beam touch, or other known or hereafter developed touch screen technologies which allow a user input by touching a portion of the display screen. The touch sensitive plate used in illustrative embodiments of game display device of the present invention is typically less than 0.01 inch in thickness. A flexible flat cable is typically used to connect the touch sensitive transparent plate to its touch screen controller, although other connections methods are also employable. The touch sensitive plate contains a matrix of touch sensitive areas over its entire surface. The outlines of these areas can be programmed to be recognized to coincide with graphics or other information displayed on the underlying display screen.

Turning now to FIGS. 1A and 2, there is shown a game or video device 10 constructed in accordance with an alternate embodiment of the present invention. Internally, the display device 10 is almost identical to that of device 10 of FIG. 1A. Essentially, the only differences as noted above are the substitution for actual rocker switches 16′ and 17′ (as opposed to touch screen interfaces), and the substitution of a single section housing 24. Corresponding modifications to the internal circuitry which are needed to accommodate the user of a mechanically actuated operator interface are believed to be well within the level of skill of the ordinary artisan and a detailed illustration and discussion of the same has been omitted herein for clarity.

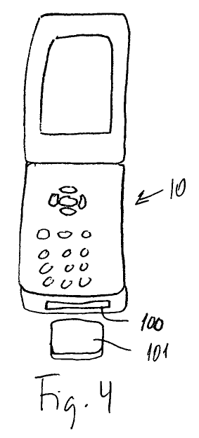

With reference now to FIG. 4, there is shown the preferred method for providing an interface to download information into display device 10. Specifically, the device 10 includes a communication interface port 100 for receiving, for example, digital data representing a replacement single game or video application. In the illustrative example of FIG. 4, the interface port 100 comprises a proprietary, non-standard PCMCIA, Mini SD, SD, Compactflash, or Sony Stick card slot, or any other card slot configuration known or hereafter developed for receiving a cartridge 19 which in this case comprises a special proprietary card memory 101 having stored thereon digital data representative of a replacement single game or video application. The data is written onto card 101 by a manufacturer and is sold as an individual game or video.

Preferably the device will automatically shut down, to conserve power, if a game is not played for 1-5 minutes, or with a video it would shut down after being paused for 3-5 minutes.

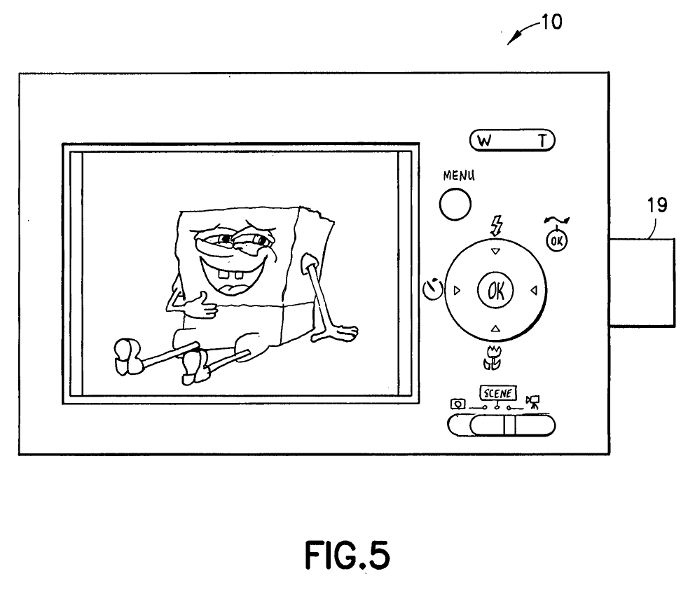

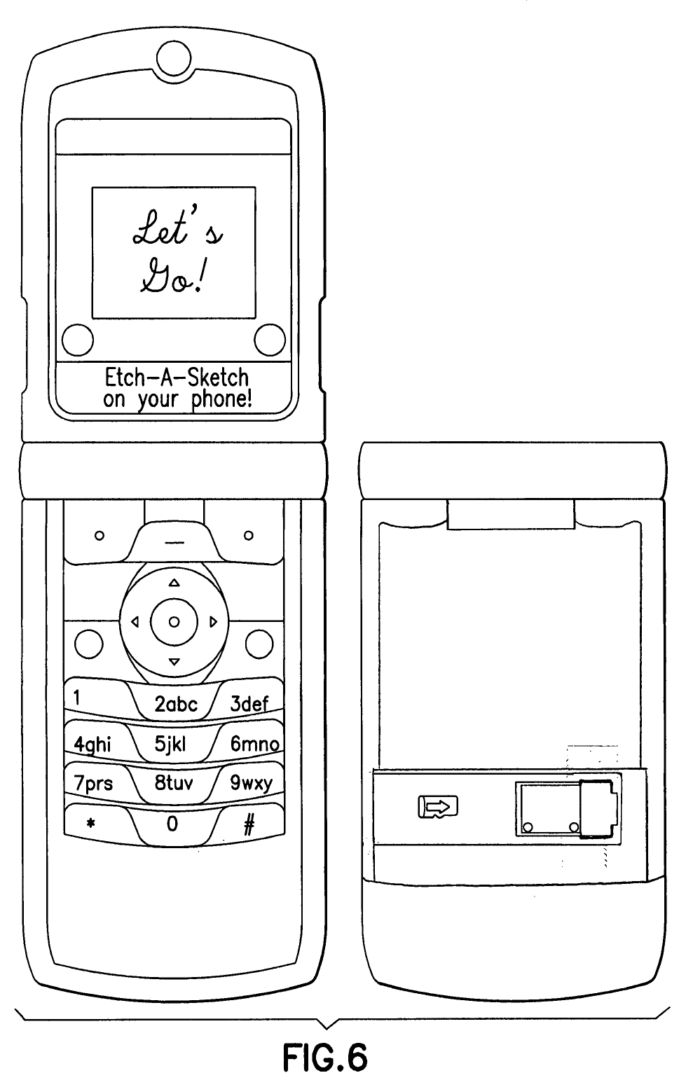

FIG. 5 is an embodiment showing a video from cartridge 19 being displayed on a digital cameral display. FIG. 6 shows a cell phone embodiment of the device 10 in which an Etch-A-Sketch™ game interface is shown on the cell phone display.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A removable cartridge for a portable device having a display and microprocessor, said cartridge comprising a memory containing a game or video application executable by the microprocessor of the portable device, the game or video application including executable steps of causing display of an initial user game interface, a video, or controls related to the game or video application upon receipt of the game cartridge in an interface port of the portable device or upon turning on the portable device with the game cartridge in the interface port, and changing the video, initial user game interface, or controls solely in response to user input.

2. The cartridge of claim 1, wherein the portable device is a mobile telephone.

3. The cartridge of claim 1, wherein the portable device is a digital camera.

4. The cartridge of claim 1, wherein the portable device is a personal digital assistant.

5. The cartridge of claim 1, wherein the portable device is a handheld game apparatus.

6. The cartridge of claim 1, wherein the initial user game interface is monochromatic screen with a visible a cursor at the center of the screen, the cursor being movable responsive to input of the user to create lines for a drawing.

7. The cartridge of claim 1, wherein the initial user game interface is a representation of a board game and the video is a movie or a feature film.

8. The cartridge of claim 1, wherein the game application includes a command for causing said processor to be set at one of a plurality of different clock speeds.

9. The cartridge of claim 1, wherein the cartridge consists of a read only memory.

10. A combination of a portable device and a machine readable storage module containing a game or video application, the portable device comprising a housing, a flat panel display received within the housing, an operator interface for inputting user commands, the operator interface comprising one of a pushbutton operator and a touch screen operator displayed on the flat panel display, an interface to receive the storage module and a processor operatively connected with the connector, the processor being responsive to the user commands to cause stored data to be read from the storage module, wherein the storage module contains a game or a video application executable by the processor, the game or video application including executable steps of causing display of an initial user game interface, a video, or controls related to the game or video application upon receipt of the game cartridge in an interface port of the portable device or upon turning on the portable device with the game cartridge in the interface port, and changing the video, initial user game interface, or controls solely in response to user input.

11. The apparatus of claim 8, wherein the portable device is a mobile telephone.

12. The apparatus of claim 8, wherein the portable device is a digital camera.

13. The apparatus of claim 8, wherein the portable device is a personal digital assistant.

14. The apparatus of claim 8, wherein the portable device is a handheld game apparatus.

15. The apparatus of claim 8, wherein the displayed game or video interface consists of
a monochromatic screen with a visible a cursor at the center of the screen, the cursor being movable responsive to input of the user to create a drawing or control a video.

16. The apparatus of claim 8, wherein the displayed game interface or displayed video controls consists of a representation of a board game, graphics or video.

17. The apparatus of claim 8, wherein the game application or video includes a command for causing said processor to be set at one of a plurality of different clock speeds.

18. A method for displaying a video or game interface on a portable electronic device with a screen, comprising the steps of:
providing a memory cartridge having a read only memory containing a game or video application executable by the microprocessor of the portable electronic device;
inserting the memory cartridge in an interface slot in the portable electronic device;
automatically recognizing the memory cartridge as containing an application to be displayed by the processor of the electronic device upon receipt of the game cartridge in an interface port of the portable device or upon turning on the portable device with the game cartridge in the interface port;
displaying an initial user game interface, a video, or controls related to the game or video application; and
changing the video, initial user game interface, or controls solely in response to user input.
